(19) United States
(12) Patent Application Publication
(10) Pub. No.: US 2025/0392085 A1
(43) Pub. Date: Dec. 25, 2025

(54) MANAGING DISCONNECTED ACCESSORY DEVICES DURING MONITORING

(71) Applicant: Stryker Corporation, Portage, MI (US)

(72) Inventors: Gretchen Nicole Rudel, Woodinville, WA (US); Lillian Aranka Steiner, Kirkland, WA (US); Stephanie Hornung, Kirkland, WA (US); Rose Tingwei Yin, Bellevue, WA (US); Nolan Frank Dost, Woodinville, WA (US); David J. Linville, Redmond, WA (US); Steven Barry Duke, Bothell, WA (US); Tyler E. Marshall, Bothell, WA (US); Nasar Hussain, Kirkland, WA (US)

(73) Assignee: Stryker Corporation, Portage, MI (US)

(21) Appl. No.: 19/244,746

(22) Filed: Jun. 20, 2025

Related U.S. Application Data
(60) Provisional application No. 63/662,840, filed on Jun. 21, 2024.

(51) Int. Cl. H01R 13/717; G06F 1/18

(52) U.S. Cl. CPC H01R 13/7175; G06F 1/188

(57) ABSTRACT

An example method includes outputting, by a connection status indicator disposed on a physiological sensor, a user-interpretable signal when the physiological sensor is communicatively disconnected from a medical device; detecting, by the physiological sensor, a physiological parameter of a subject; and outputting, by the physiological sensor to the medical device, data indicating the physiological parameter when the physiological sensor is communicatively connected to the medical device.

### CROSS-REFERENCE TO RELATED APPLICATION

This application claims priority to U.S. Provisional App. No. 63/662,840, which was filed on Jun. 21, 2024 and is incorporated by reference herein in its entirety.

### BACKGROUND

In the event of a patient experiencing a sudden medical emergency, rescuers are deployed to the location of the person to provide assistance and potential transport. Rescuers utilize portable medical devices, such as monitor-defibrillators and mechanical chest compression devices, to monitor and treat the patient. If the patient needs additional medical care, the rescuers transport the person to a clinical environment. The portable medical devices can utilize removably connected accessory devices to monitor and treat the patient. For instance, a blood pressure cuff can plug into a monitor-defibrillator during use and can report blood pressure measurements of the patient to the monitor-defibrillator.

### BRIEF DESCRIPTION OF THE DRAWINGS

FIG. 1 illustrates an example environment of a rescue scene including an accessory device that is configured to notify a rescuer when it is disconnected from a medical device, and to report measurements that the accessory device detects when the accessory device is disconnected from the medical device.

FIG. 2 illustrates an environment of an example accessory device and an example medical device in accordance with various implementations of the present disclosure.

FIGS. 3A and 3B illustrate example accessory devices configured to report their connection statuses.

FIGS. 4A and 4B illustrate examples of measurement data transmitted by an accessory device to a medical device.

FIG. 5 illustrates an example process for reporting a connection status and physiological parameter detected by an accessory device when the accessory device is disconnected from a medical device.

FIG. 6 illustrates an example process for temporarily storing measurement data in memory when an accessory device is disconnected from a medical device.

FIG. 7 illustrates an example of an external defibrillator configured to perform various functions described herein.

FIG. 8 illustrates a chest compression device configured to perform various functions described herein.

### DETAILED DESCRIPTION

Accessory devices enable many portable medical devices to detect physiological parameters of a patient and to administer treatments to the patient. However, if the accessory devices become disconnected from the portable medical devices, then the portable medical devices are unable to utilize the functionality of the accessory devices. For example, if a blood pressure cuff is unplugged from a monitor-defibrillator, such as when the patient being monitored is moved from the ground to a cot for transport, the monitor-defibrillator is unable to receive the blood pressure measurements of the patient. Without the blood pressure measurements, the monitor-defibrillator may be unable to identify if the patient experiences a sudden loss of circulation. If left unidentified for an extended period of time, the loss of circulation could result in permanent harm to the patient.

Various implementations described herein relate to accessory devices and accessory device hubs configured to maintain data integrity of physiological parameter measurements acquired when disconnected from a medical device. In various cases, an example accessory device temporarily stores data indicative of physiological measurements when the device is communicatively disconnected from a medical device. In some examples, the accessory device also temporarily utilizes an on-board power source when it is disconnected from a power source in the medical device. Upon being reconnected to the medical device, the accessory device may transmit the stored data to the medical device. Accordingly, the medical device may maintain a continuous record of the physiological measurements despite being disconnected from the accessory device.

In some implementations, an accessory device detects when it has been communicatively disconnected from a medical device. The accessory device, for instance, outputs a signal to a user indicating that the accessory device has been disconnected. In some examples, the signal is output from a portion of the accessory device that is disposed on the body of a patient being monitored, such that the signal can be easily discerned by a user who is actively monitoring or treating the patient.

Various implementations of the present disclosure are directed to improvements in the technical field of physiological monitoring. Previously, an accessory device was not capable of monitoring a patient when it was disconnected from its base medical device. When the accessory device was inadvertently or intentionally unplugged from the base medical device, such as during a high-stress patient transport scenario, the base medical device would not be able to receive physiological parameter measurements from the accessory device. As a result, the base medical device may be unable to identify or report serious medical conditions of the patient that would be apparent based on the missing physiological parameter measurements. In various implementations of the present disclosure, measurements obtained when an accessory device is unplugged from a base medical device can be provided to the base medical device, thereby enabling the base medical device to report the measurements and/or identify the serious medical conditions.

In some cases, a previous accessory device was an active element that was reliant on the medial device as a source of power in order to take physiological parameter measurements. Further, even if the accessory device had an independent power source, that power source could become depleted quickly during a rescue event. Moreover, it was inconvenient for rescuers to recharge accessory devices separately from the base medical device. By selectively enabling an accessory device to draw power from an on-board power source, which can be recharged when it is connected to the base medical device, implementations of the present disclosure enable the accessory device to continue to monitor a patient even when the accessory device is disconnected from the base medical device. Moreover, in examples in which the accessory device can be recharged using the medical device itself during use, the accessory device can be recharged more conveniently than other types of rechargeable devices.

Further, in some previous cases, an accessory device was deactivated when it became unplugged from the base medical device. If the accessory device was inadvertently unplugged from the medical device, the user may not notice for an extended period of time, which could cause significant interruptions in patient monitoring and care. In various implementations described herein, an accessory device reports that it has been disconnected from the base medical device in a manner that would be easily discernible to a user during a high-stress rescue event.

Implementations of the present disclosure will now be described with reference to the accompanying figures.

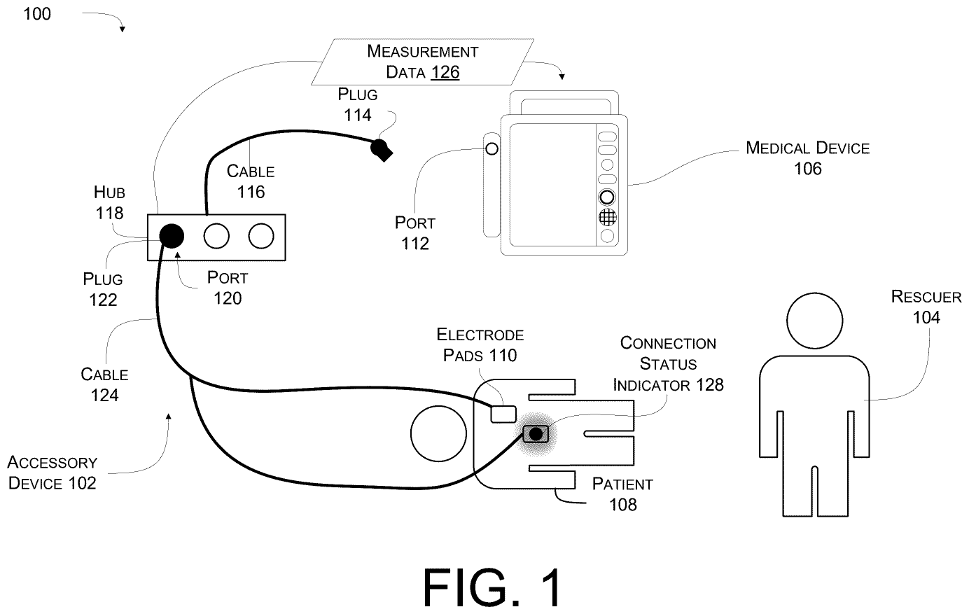

FIG. 1 illustrates an example environment 100 of a rescue scene including an accessory device 102 that is configured to notify a rescuer 104 when it is disconnected from a medical device 106, and to report measurements that the accessory device 102 detects when the accessory device 102 is disconnected from the medical device 106. In some implementations, the rescuer 104 is deployed to the environment 100 in response to the patient 108 experiencing a medical emergency. For instance, the patient 108 may have suddenly collapsed within the environment 100 due to cardiac arrest or some other serious medical condition.

In various examples, the environment 100 is part of a non-clinical environment, such as outside of a hospital, clinic, hospice, or other environment with readily available care providers and medical equipment. For example, the patient 108 may have collapsed in a public area, such as a school or airport. As a result, the rescuer 104 may have physically carried the medical device 106 to the environment in response to an emergency call reporting the condition of the patient 108. The medical device 106, for instance, may be a portable device including a rigid housing and a battery that enables the medical device 106 to be utilized in conditions in which mains current is unavailable. In some examples, the medical device 106 is a defibrillator, such as an automated external defibrillator (AED) or a monitor-defibrillator. In some examples, the medical device 106 is another type of portable medical device, such as a mechanical chest compression device, a portable ventilator, a portable ultrasound monitor, a flow monitor, or a portable patient monitor of any type.

The accessory device 102 is configured to detect at least one physiological parameter of a patient 108 via electrode pads 110 disposed on the patient 108. The terms “physiological parameter,” “parameter,” and their equivalents, may refer to a metric that is indicative of a condition of a subject's body. Examples of physiological parameters include, for instance, an electrocardiogram (ECG), a blood pressure, a blood oxygenation (e.g., regional oxygenation, pulse oxygenation, plethysmograph, etc.), an airway parameter (e.g., a capnograph, a partial pressure of CO2, a partial pressure of O2, a tidal volume, flow rate through an airway, airway pressure, respiration rate, etc.), a temperature (e.g., a core temperature, a temperature of an extremity, etc.), a blood flow (e.g., a blood velocity, blood flow rate, etc.), a heart rate, a pulse rate, a motion (e.g., an acceleration), a concentration of a chemical in a body fluid (e.g., blood glucose), or any combination thereof.

In various cases, multiple electrode pads 110 are adhered to the skin of the patient 108. Each of the electrode pads 110, for instance, includes an electrically insulative substrate, an electrically conductive hydrogel disposed on the electrically insulative substrate, and an electrode layer disposed between the electrically insulative substrate and the electrically conductive hydrogel. The electrode layer, for instance, includes a metal. In various implementations, the electrode pads 110 are disposed on the chest of the patient 108. The accessory device 102 may detect a relative electrical potential between the electrode layers of the electrode pads 110 over time, due to an electrical signal output by the heart of the patient 108. Accordingly, the accessory device 102 is configured to detect an ECG of the patient 108.

Although not specifically illustrated in FIG. 1, implementations of the present disclosure include accessory devices that omit the electrode pads 110 and/or include one or more other types of sensors. In various cases, the sensor(s) include one or more electrodes, a blood pressure sensor (e.g., a catheter-based sensor, a blood pressure cuff, an ultrasound-based blood pressure sensor, etc.), an oxygenation sensor (e.g., an oximeter), a pressure sensor, a flow sensor, a gas sensor, a blood flow sensor (e.g., an ultrasound transducer configured to perform Doppler-based measurements on blood flow), an accelerometer, a gyroscope, a chemical sensor, or any combination thereof. In various examples, the accessory devices may be configured to administer a treatment to a subject. For instance, the accessory devices may include defibrillation electrodes, laryngoscopes, ventilation devices, chest compression devices (e.g., a band or plunger configured to administer chest compressions), or any combination thereof. In some cases, the accessory devices include other elements, such as printers, recording devices, external display devices, and the like.

In some examples, the accessory device 102 is configured to administer a treatment to the patient 108. For instance, the medical device 106 may output, to the electrode pads 110, an electrical shock that is configured to defibrillate the heart of the patient 108. In some cases, the medical device 106 outputs pulses that provide pacing to the heart of the patient 108. Although not specifically illustrated in FIG. 1, implementations of the present disclosure include accessory devices that omit the electrode pads 110 and/or include one or more other types of treatment devices. Examples of treatment devices include plungers and bands for administering chest compressions to the patient 108; pumps, bag-valve masks, and airway adaptors for administering positive pressure breaths to the airway of the patient 108; pumps for administering medications to the patient 108; or the like.

In various examples, the accessory device 102 receives power and transmits data to the medical device 106 via a wired interface. Specifically, the medical device 106 includes a port 112 that is configured to receive a plug 114 of the accessory device 102. As used herein, the term “plug,” and its equivalents, may refer to a physical connector that can be removably inserted into a port, and which electrically connects the port to a circuit coupled to the plug when the plug is physically inserted into the port. The plug 114 of the accessory device 102 is configured to be removably coupled with the port 112 of the medical device 106. For example, the plug 114 may be configured to be magnetically coupled, snap-fit, or tension-fit into the shape of the port 112. In various cases, the plug 114 includes one or more conductive contacts that are configured to be disposed against one or more conductive contacts of the port 112 when the plug 114 is connected to the port 112. Accordingly, electrical signals can be transmitted between the plug 114 and the port 112 when the plug 114 is connected to the port 112.

The plug 114 is connected to at least one cable 116 configured to carry electrical signals. In various cases, the cable 116 includes one or more elongated conductive wires that are electrically coupled to the plug 114. The conductive wire(s) are configured to carry the electrical signals to and/or from the plug 114. In some cases, the cable 116 further includes an insulative covering. In some cases, the covering includes a polymer, a rubberized material, a woven material, or the like. The cable 116 is flexible, in various implementations.

In some implementations, the accessory device 102 includes a hub 118 that is configured to be connected with multiple sensors. For instance, the cable 116 may extend between the hub 118 and the plug 114. In various cases, the cable 116 is configured to communicatively and/or electrically connect the hub 118 and the plug 114. In some cases, the presence of the hub 118 prevents the accessory device 102 from being disconnected from the medical device 106. For example, the hub 118 may be physically mounted on a support apparatus (not illustrated) on which the patient 108 is disposed, such as a cot used to transport the patient 108. As a result, the plug 122 may be prevented from being removed from the port 120 when the patient 108 is moved throughout the environment 100 on the support apparatus.

In some cases, the hub 118 includes multiple ports that are configured to be removably coupled to additional cables that are respectively connected to sensors. For instance, the hub 118 includes a port 120 that is configured to be removably coupled with an additional plug 122 connected to an additional cable 124. The additional cable 124, for instance, communicatively and/or electrically connects the electrode pads 110 to the plug 122. Although not specifically shown, the hub 118 may be configured to connect to multiple sensor and/or treatment devices. The hub 118 may electrically and/or communicatively connect the multiple sensor and/or treatment devices to the medical device 106 via the cable 116 and the plug 114, or via one or more additional cables and plugs configured to be connected with additional ports of the medical device 106.

When the plug 114 is coupled with the port 112 and the plug 122 is coupled with the port 120, the accessory device 102 and the medical device 106 may operate in a default mode. In some cases, the medical device 106 may provide power to the hub 118 and the electrode pads 110. For example, the cable 116 may connect a power source in the medical device 106 with a circuit in the hub 118. In some examples, the circuit in the hub 118 outputs an electrical signal (e.g., a current) to the electrode pads 110. The circuit may further detect a relative voltage between the electrode pads 110. Samples of the relative voltage may correspond to ECG measurements of the patient 108.

In various cases, the hub 118 may generate measurement data 126 based on the ECG measurements of the patient 108. When the plug 114 is connected to the medical device 106, the hub 118 may transmit the measurement data 126 to the medical device 106 via the cable 116. In turn, the medical device 106 can perform one or more actions based on the measurement data 126. In some examples, the medical device 106 displays a waveform based on the measurement data 126 (e.g., a waveform indicative of the ECG measurements of the patient 108). In some cases, the medical device 106 determines characteristics of the measurement data 126 (e.g., a heart rate of the patient 108) and outputs the characteristics. In some examples, the medical device 106 determines whether the measurement data 126 is indicative of a particular condition (e.g., ventricular fibrillation (VF)) and reports the predicted presence or absence of the condition to the rescuer 104. The medical device 106, for instance, includes one or more output devices configured to output various information described herein to the rescuer 104. For example, the medical device 106 may include a display (e.g., a screen), a speaker, a haptic feedback device, or any other output device described herein. In some implementations, the medical device 106 outputs a signal that causes the accessory device 102 to administer a treatment (e.g., an electrical shock) to the suspected condition of the patient 108 in response to analyzing the measurement data 126.

Accordingly, when the accessory device 102 is physically connected to the medical device 106 via the plug 114, the accessory device 102 may draw power from the medical device 106 and/or transmit data to the medical device 106 via the cable 116. However, when the plug 114 is disconnected from the port 112, the accessory device 102 may be unable to draw power from the medical device 106 and/or may be unable to transmit the measurement data 126 to the medical device 106 over the cable 116. When the plug 114 is disconnected from the port 112, the accessory device 102 and/or the medical device 106 may operate in a disconnect mode.

In various implementations of the present disclosure, the accessory device 102 is configured to transition to drawing power from a power source within the accessory device 102 when the accessory device 102 is unable to draw power from the medical device 106. The power source, for instance, includes at least one of a battery, a capacitor, or an antenna configured to receive power wirelessly from an external device. As a result, the accessory device 102 may continue to detect the ECG of the patient 108 via the electrode pads 110 and to generate the measurement data 126 when the accessory device 102 is physically disconnected from the medical device 106. Similarly, other sensors and/or treatment devices connected to the hub 118 may be configured to detect at least one physiological parameter and/or administer at least one treatment to the patient 108 by drawing power from the power source within the accessory device 102.

In some cases, the power source in the accessory device 102 is charged when the medical device 106 is connected to the accessory device 102 via the plug 114. In some examples, the power source of the accessory device 102 is configured to be charged wirelessly from a charging source (not illustrated). For example, the power source may include an antenna configured to receive an electromagnetic signal from a charging source, wherein the electromagnetic signal induces a current in a circuit including the antenna. That current, for instance, can supply power to various active elements of the accessory device 102. In some cases, the power source in the accessory device 102 includes a rechargeable battery, a capacitor, or some other storage device that stores a voltage in response to receiving a current from the power source of the medical device 106. When the power source of the medical device 106 is electrically disconnected from the power source in the accessory device 102, the storage device may discharge a current to a circuit in the accessory device 102.

In some cases, the accessory device 102 is configured to wirelessly transmit the measurement data 126 generated when the plug 114 is disconnected from the port 112. The accessory device 102 may include a transmitter and/or transceiver configured to transmit, to the medical device 106, a communication signal to the medical device 106. According to some cases, the communication signal includes a stream of data packets that are transmitted to the medical device 106 substantially in real time as the accessory device 102 generates the measurement data 126. In some implementations, the accessory device 102 undergoes a pairing operation with the medical device 106 that establishes a wireless interface between the accessory device 102 and the medical device 106. One or more types of wireless communication protocols can be utilized to transmit the measurement data 126, such as a BLUETOOTH™ or Near-Field Communication (NFC) communication protocol.

In various implementations, the accessory device 102 may preferentially transmit the measurement data 126 to the medical device 106 via the wired interface including the plug 114 and the port 112 when the plug 114 is connected to the port 112, rather than the wireless interface, for various reasons. These reasons include, for instance, that activating the transmitter of the accessory device 102 to perform wireless transmission may require greater power consumption, that transmitting the measurement data 126 wirelessly is associated with a greater transmission latency, and/or that transmitting the measurement data 126 wirelessly is associated with a greater number of potential errors in the data received by the medical device 106, as compared to wired transmission. In various cases, the accessory device 102 disconnects the power source from circuitry in the accessory device 102 and/or deactivates the transmitter when the plug 114 is connected to the port 112. Accordingly, limited power stored in the on-board power source of the accessory device 102 may be conserved for temporary conditions in which the accessory device 102 can no longer draw power from the medical device 106 directly. Furthermore, by preferentially transmitting the measurement data 126 over the cable 116 when the option is available, errors and delays in transmission of the measurement data 126 via the wireless interface may be prevented.

In some cases, the accessory device 102 may refrain from transmitting the measurement data 126 wirelessly to the medical device 106. For instance, the accessory device 102 may temporarily store a portion of the measurement data 126 generated when the accessory device 102 is physically disconnected from the medical device 106. When the accessory device 102 is reconnected with the medical device 106, the accessory device 102 may transmit the historic portion of the measurement data 126 along with a real-time portion of the measurement data 126 being generated as the accessory device 102 is connected with the medical device 106.

In some cases, the accessory device 102 may transmit the historic portion of the measurement data 126 interleaved with the real-time portion of the measurement data 126 over the cable 116. For example, the accessory device 102 may transmit a stream of data packets containing the measurement data 126, wherein a first data packet may correspond to the historic portion of the measurement data 126, a second data packet may correspond to the real-time portion of the measurement data 126, a third data packet may correspond to the historic portion of the measurement data 126, and so on. Accordingly, the accessory device 102 may transmit the historic portion of the measurement data 126 without significantly delaying the transmission of the real-time portion of the measurement data 126 to the medical device 106.

Moreover, the accessory device 102 may apply techniques that efficiently communicate whether the accessory device 102 is disconnected from the medical device 106. In a high-stress rescue environment, it may be easy for the plug 114 to inadvertently become dislodged from the port 112. For example, the rescuer 104 may be physically moving the patient 108 and the hub 118 to provide care to the patient 108, which may result in a sudden increase in the distance between the hub 118 and the medical device 106 that exceeds the length of the cable 116 and that results in the plug 114 leaving the port 112. It may be preferred to operate the accessory device 102 while the plug 114 is connected to the port 112. For instance, the on-board power source of the accessory device 102 may be limited, such that the accessory device can only operate while separated from the medical device 106 for a limited amount of time. In some cases, the accessory device 102 may wait to transmit the measurement data 126 to the medical device 106 until the plug 114 is connected to the port 112, which means that the medical device 106 may be unable to report and/or analyze the measurement data 126 when the accessory device 102 is disconnected. Thus, reducing the time during which the plug 114 is disconnected from the port 112 may reduce the time during which the medical device 106 is unable to report and/or analyze the condition of the patient 108. However, it may be difficult for the rescuer 104 to recognize that the accessory device 102 has become disconnected from the medical device 106 while the rescuer 104 is focusing on managing care to the patient 108 (e.g., performing chest compressions, administering assisted ventilation, administering a medication to the patient 108, etc.). In particular cases, the rescuer 104 may be watching the patient 108 rather than the medical device 106.

In various implementations of the present disclosure, the electrode pads 110 include a connection status indicator 128 that indicates whether the accessory device 102 is disconnected from the medical device 106. That is, the connection status indicator 128 is located on a portion of the accessory device 102 that is attached to the body of the patient 108. Accordingly, the connection status indicator 128 may more efficiently report whether the accessory device 102 is connected to the medical device 106 than the medical device 106 itself.

In some implementations, the connection status indicator 128 includes at least one light source configured to output light indicating whether the accessory device 102 is disconnected from the medical device 106. In some cases, the connection status indicator 128 outputs light when the accessory device is disconnected from or connected to the medical device 106. In some examples, the connection status indicator 128 outputs light having a first wavelength (i.e., color) when the accessory device 102 is connected to the medical device 106 and light having a second wavelength when the accessory device 102 is disconnected from the medical device 106. For instance, the connection status indicator 128 may output green light when the accessory device 102 is connected to the medical device 106 and may output red light when the accessory device 102 is disconnected from the medical device 106. In some examples, the connection status indicator 128 outputs light having a first pulse pattern (e.g., pulse duration and/or frequency) when the accessory device 102 is connected with the medical device 106 and a second pulse pattern when the accessory device 102 is disconnected from the medical device 106. For instance, the connection status indicator 128 may output light continuously when the accessory device 102 is connected with the medical device 106 and may blink when the accessory device 102 is disconnected from the medical device 106.

In some examples, the connection status indicator 128 includes a speaker configured to output sound indicating whether the accessory device is disconnected from the medical device 106. For example, the connection status indicator 128 may output an audible prompt (e.g., “electrode disconnected”) when the accessory device 102 is disconnected from the medical device 106. In some cases, the connection status indicator 128 outputs a sound at a particular frequency or duration indicating whether the accessory device 102 is disconnected from the medical device 106.

The connection status indicator 128, in some implementations, includes one or more other types of output devices. For instance, the connection status indicator 128 may include a haptic feedback device configured to vibrate in a manner indicative of whether the accessory device 102 is connected to the medical device 106. In some cases, the connection status indicator 128 includes at least one of a display (e.g., a screen), a transceiver, a color-changing substate, or the like, that outputs a signal indicating whether the accessory device 102 is connected to the medical device 106.

In various examples, a circuit within the accessory device 102 is configured to detect whether the accessory device 102 is connected to the medical device 106 and to control the connection status indicator 128 based on whether the accessory device 102 is connected to the medical device 106. According to some cases, the circuit within the accessory device 102 pings the medical device 106 periodically in order to assess whether the medical device 106 is connected. In various instances, the circuit within the medical device 106 changes state (e.g., activates a switch) in response to the power source in the medical device 106 being disconnected from the circuit in the accessory device 102. In some examples, the circuit includes a switch that selectively supplies power to the connection status indicator 128 when the accessory device 102 is disconnected from the medical device 106. In some instances, the circuit within the medical device 106 outputs a signal to the connection status indicator 128 that is indicative of whether the accessory device 102 is connected to the medical device 106, thereby causing the connection status indicator 128 to output the signal indicating the connection status of the accessory device 102 to the rescuer 104.

Although FIG. 1 illustrates that the accessory device 102 includes a hub 118, implementations are not so limited. In some cases, the accessory device 102 includes a single cable that is configured to connect a sensor and/or treatment device directly with the port 112 of the medical device 106.

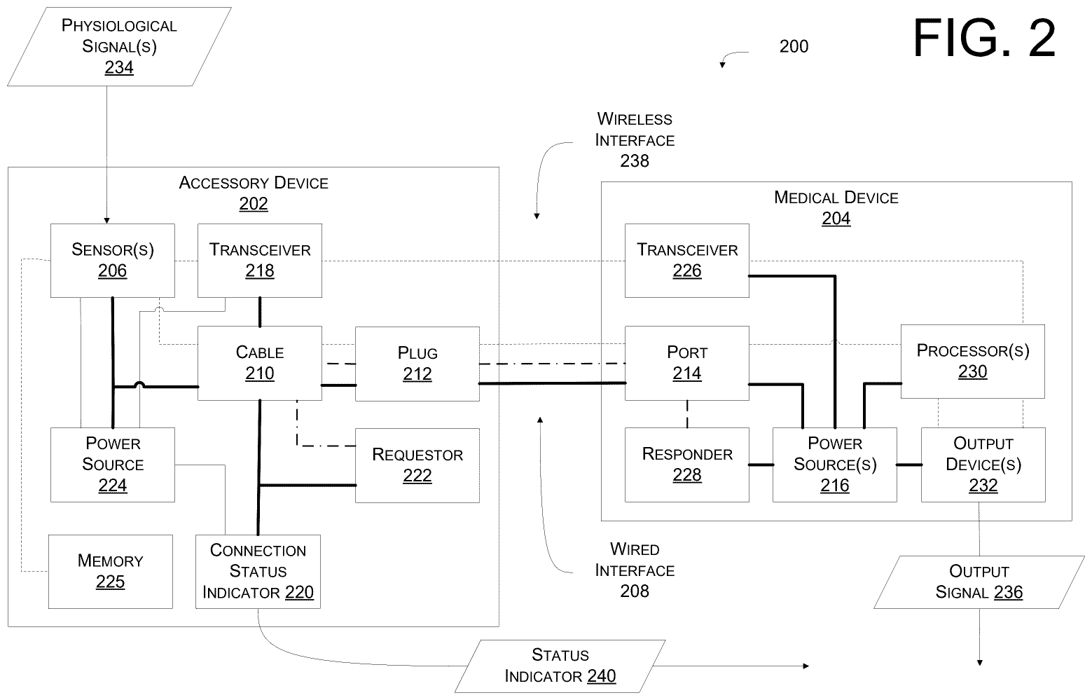

FIG. 2 illustrates an environment 200 of an example accessory device 202 and an example medical device 204 in accordance with various implementations of the present disclosure. In some cases, the accessory device 202 corresponds to the accessory device 102 and the medical device 204 corresponds to the medical device 106.

In various implementations, the accessory device 202 includes one or more sensors 206 configured to detect at least one physiological parameter of a subject, such as a patient.

The sensor(s) 206, for instance, may be active elements that utilize electrical power in order to detect the physiological parameter(s). In various cases, the accessory device 202 receives power to activate the sensor(s) 206 via a wired interface 208 that connects the accessory device 202 to the medical device 204. In various cases, the wired interface 208 includes a cable 210 and a plug 212 of the accessory device 202, as well as a port 214 of the medical device 204. The plug 212 is configured to be removably coupled with the port 214.

When the plug 212 is physically coupled with the port 214, the accessory device 202 may be supplied with power from the medical device 204 over the wired interface 208. The medical device 204 includes one or more power sources 216. The power source(s) 216, for instance, include at least one of a plug configured to connect to mains current, a battery, a capacitor, a wireless charging antenna, some other power storage device, or any combination thereof. In some cases, the power source(s) 216 includes at least one rechargeable power source.

The power source(s) 216 of the medical device 204 supplies power to various elements in the accessory device 202 when the wired interface 208 connects the accessory device 202 and the medical device. For instance, the power source(s) 216 supplies power to the sensor(s) 206, as well as a transceiver 218, a connection status indicator 220, a requester 222, and a power source 224 in the accessory device 202. Optionally, the power source(s) 216 supply power to memory 225 in the accessory device 202. Further, the power source(s) 216 of the medical device 204 supplies power to various elements in the medical device 204, such as a transceiver 226, a responder 228, one or more processors 230, and one or more output device(s) 232. Dark bold lines in FIG. 2 illustrate paths of supplied power from the power source(s) 216 of the medical device 204 when the wired interface 208 connects the accessory device 202 and the medical device 204.

During a connected mode, the accessory device 202 and the medical device 204 operate using power from the power source(s) 216. For instance, the sensor(s) 206 detect the physiological parameter(s) by detecting one or more physiological signal(s) 234 from a subject. In various cases, the sensor(s) 206 generate analog signals based on the physiological signal(s) 234. In some examples, the sensor(s) 206 convert the analog signals to digital signals. Both the analog signals and the digital signals are indicative of the physiological parameter(s). The analog signals and/or digital signals are transmitted by the accessory device 202 to the medical device 204 over the wired interface 208. The processor(s) 230 of the medical device 204 analyze the signals received from the accessory device 202. For instance, the processor(s) 230 may predict whether the subject is exhibiting a condition based on the physiological parameter(s) detected by the sensor(s) 206. In various cases, the processor(s) 230 cause the output device(s) 232 to output an output signal 236 based on the signals generated by the sensor(s) 206. For instance, the output signal 236 may indicate a physiological parameter of the subject, an indication of whether the subject is predicted to exhibit a particular condition, a recommendation for administering a treatment to the subject, or any combination thereof.

Optionally, the transceiver 218 of the accessory device 202 and the transceiver 226 of the medical device 204 are configured to exchange data over a wireless interface 238. For example, the wireless interface 238 carries the transmission of electromagnetic signals and/or sound that encode data. Examples of data that can be transmitted between the transceiver 218 and the transceiver 226 include data indicative of the physiological parameter(s) of the subject, as detected by the sensor(s) 206. However, in some cases, the wireless interface 238 is not established when the wired interface 208 connects the accessory device 202 and the medical device 204.

In various implementations, the connection status indicator 220 outputs a status indicator 240 using power from the power source(s) 216. The status indicator 240, for instance, indicates that the plug 212 and the port 214 are physically coupled to each other. In some cases, the status indicator 240 includes a light signal, sound, a haptic feedback signal, or any combination thereof. The connection status indicator 220, in some cases, is integrated into a housing of the sensor(s) 206. The connection status indicator 220 may be disposed in proximity to the body of the subject.

In some cases, the requester 222 is configured to determine whether the accessory device 202 is connected with the medical device 204 by pinging the responder 228 in the medical device 204. For instance, the requestor 222 is configured to periodically transmit an echo request over the cable 210. Upon receiving the echo request, the responder 228 may transmit an echo reply from the port 214. If the requestor 222 receives the echo reply within a threshold time period of transmitting the echo request, then the requestor 222 may infer that the wired interface 208 connects the accessory device 202 to the medical device 204. If the requestor 222 does not receive the echo reply within the threshold time period of transmitting the echo request, then the requester may infer that the wired interface 208 is disconnected. In various cases, the requestor 222 and/or the responder 228 can be implemented in one or more processors, software, hardware, or any combination thereof.

According to some implementations, the requestor 222 is configured to detect whether the wired interface 208 connects the accessory device 202 to the medical device 204 by detecting an electrical signal (e.g., a voltage) at the cable 210 or some other portion of the accessory device 202. For example, when the wired interface 208 is disconnected, the electrical signal at the cable 210 may jump to a different level due to the discontinuity between the power source(s) 216 and the accessory device 202. In some cases, the responder 228 is omitted from the medical device 204.

The power source 224, in some cases, is charged based on power received from the power source(s) 216 when the wired interface 208 connects the accessory device 202 and the medical device 204. In some cases, the power source 224 is disconnected from the circuit including the power source(s) 216 when a charge level of the power source 224 exceeds a threshold. In some cases, the power source 224 is charged based on another source.

The memory 225, in various implementations, is configured to at least temporarily store data generated by the sensor(s) 206 and/or data received from the medical device 204. In some examples, the memory 225 refrains from storing data while the wired interface 208 connects the accessory device 202.

In some implementations, the wired interface 208 is disconnected. For instance, the plug 212 may be removed from the port 214. When the wired interface 208 is disconnected, the accessory device 202 and the medical device 204 may operate in a disconnected mode.

The accessory device 202 is unable to receive power from the power source(s) 216 in the medical device 204 when the wired interface 208 is disconnected. Accordingly, in the disconnected mode, the accessory device 202 may switch to utilizing power from the on-board power source 224. In various cases, power stored in the power source 224 may be discharged from the power source 224 to elements within the accessory device 202 when the wired interface 208 is disconnected. For example, the power source 224 may at least temporarily output power to the sensor(s) 206, the transceiver 218, the connection status indicator 220, the requestor 222, the memory 225, or any combination thereof.

The sensor(s) 206 may continue to detect the physiological signal(s) 234 in the disconnected mode. In some examples, the data generated by the sensor(s) 206 that is indicative of the physiological parameter(s) is transmitted by the transceiver 218 to the transceiver 226 over the wireless interface 238 when the wired interface 208 is interrupted. However, in some cases, the interruption in the wired interface 208 may also interrupt the communicative coupling between the medical device 202. For example, the transceiver 218 may be omitted from the accessory device 202. According to some implementations, the data generated by the sensor(s) 206 is at least temporarily stored in the memory 225 when the wired interface 208 is interrupted. If the accessory device 202 later determines that the wired interface 208 has been restored, the accessory device 202 may output the data stored in the memory 225 to the wired interface 208. In various implementations, the continuity of physiological monitoring performed via the accessory device 202 can be maintained even if the wired interface 208 is disconnected.

In various cases, the connection status indicator 220 further updates the status indicator 240 when the accessory device 202 is in the disconnected mode. In some cases, the connection status indicator 220 selectively outputs the status indicator 240 when the accessory device 202 is operating in the disconnected mode. In some examples, the connection status indicator 220 refrains from outputting the status indicator 240 when the accessory device 202 is operating in the connected mode. According to some instances, the status indicator 240 has a different characteristic when the accessory device 202 is operating in the disconnected mode, as compared to when the accessory device 202 is operating in the connected mode. For example, the status indicator 240 may have a different frequency, pulse pattern, color, tone, brightness, intensity, or any combination thereof, when the accessory device 202 is operating in the disconnected mode as compared to when the accessory device 202 is operating in the connected mode. Accordingly, a user (e.g., a rescuer) can easily discern the connection status of the accessory device 202 while monitoring and treating the subject.

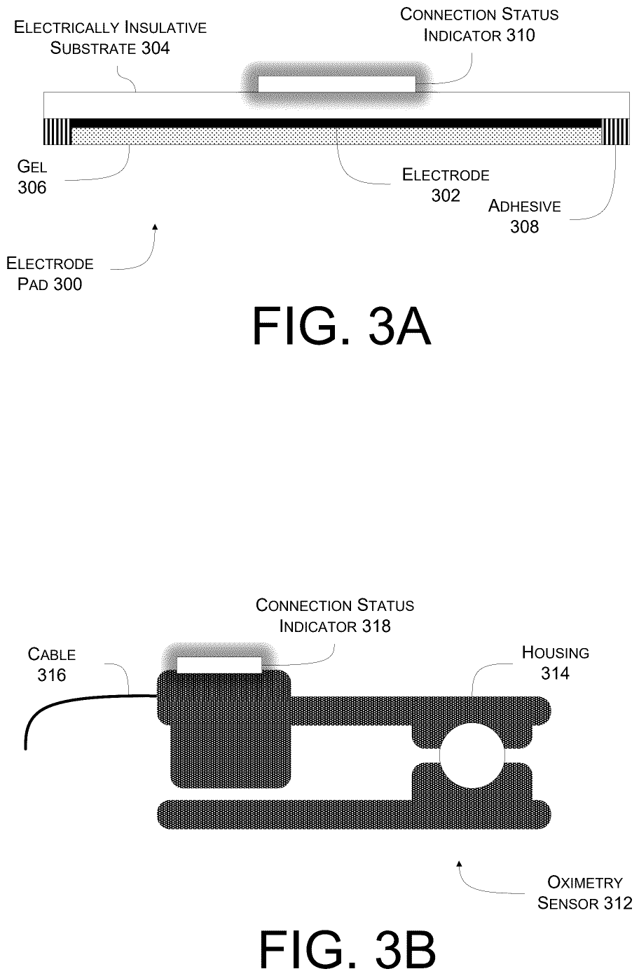

FIGS. 3A and 3B illustrate example accessory devices configured to report their connection statuses. FIG. 3A is a cross-sectional view of an example electrode pad 300 that can report its connection status. The electrode pad 300, for instance, is one of the electrode pads 110 described above.

The electrode pad 300 includes an electrode 302 that is configured to conduct electrical signals to and/or from a subject. The electrode 302, for instance, includes silver-silver chloride (Ag/AgCl), nickel, another conductive material, or any combination thereof. The electrode 302 is disposed on an electrically insulative substrate 304. For example, the electrically insulative substrate 304 includes a foam, a rubberized material, a polymer, or some other electrically insulative material. A gel 306 is disposed on the electrode 302, such that the electrode 302 is disposed between the electrically insulative substrate 304 and the gel 306. The gel 306 is electrically conductive. For instance, the gel 306 is a hydrogel including one or more electrolytes. An adhesive 308 is disposed on a perimeter of a side of the electrically insulative substrate 304 that is disposed against the electrode 302, such that the adhesive 308 is disposed around a border of the electrode 302 and the gel 306. The adhesive 308 is configured to attach the electrode pad to the skin of a subject. For instance, the adhesive 308 is biocompatible.

In various implementations of the present disclosure, the electrode pad 300 further includes a connection status indicator 310. The connection status indicator 310 is an output device configured to output, to a user, a signal indicating whether the electrode pad 300 is plugged into a medical device or otherwise connected with the medical device. For instance, the connection status indicator 310 may be one or more lights, a speaker, a haptic feedback device, or any combination thereof. In some cases, the connection status indicator 310 outputs a signal exclusively when the electrode pad 300 is disconnected from the medical device, and refrains from outputting the signal when the electrode pad 300 is connected with the medical device. In some examples, the connection status indicator 310 outputs a first signal when the electrode pad 300 is disconnected from the medical device, and outputs a second signal when the electrode pad 300 is connected to the medical device. For instance, the first and second signals may have different frequencies, durations, pulse patterns, periods, colors, tones, intensities, or any combination thereof.

Although not specifically illustrated in FIG. 3A, the electrode 302 and the connection status indicator 310 may be electrically coupled to one or more wires within a cable extending from the electrode pad 300. In some cases, the electrode 302 and the connection status indicator 310 are connected to a power source of the electrode pad, such as when the electrode pad 300 is disconnected from the medical device. In some examples, the electrode 302 and the connection status indicator 310 are electrically connected to a power source in the medical device when the electrode pad 300 is connected with the medical device. Thus, the electrode 302 and/or the connection status indicator 310 may be powered regardless of whether the electrode pad 300 is connected to the medical device.

FIG. 3B is a view of an example oximetry sensor 312 that can report its connection status. For instance, the oximetry sensor 312 may be configured to be connected to the hub 118 and/or the medical device 106 described above.

The oximetry sensor 312 includes a housing 314 that at least partially encloses circuitry within the oximetry sensor 312. In various cases, the housing 314 is configured to be removably coupled with a finger of a subject. The oximetry sensor 312, for instance, includes at least one light source configured to emit light through the finger of the subject. The oximetry sensor 312 may further include at least one light sensor configured to detect light that is emitted through and/or scattered by the finger of the subject. The amount of light detected by the light sensor(s) is indicative of a blood oxygenation of the subject. Thus, the oximetry sensor 312 may detect the blood oxygenation of the subject when the oximetry sensor 312 is appropriately positioned on the subject's finger. An electrical signal (e.g., a digital signal) indicative of the blood oxygenation can be transmitted from the oximetry sensor 312 to a medical device via a cable 316.

In various implementations of the present disclosure, a connection status indicator 318 is disposed in and/or on the housing 314 of the oximetry sensor 312. The connection status indicator 318 is an output device configured to output, to a user, a signal indicating whether the oximetry sensor 312 is plugged into a medical device or otherwise connected with the medical device (e.g., via the cable 316). For instance, the connection status indicator 318 may be one or more lights, a speaker, a haptic feedback device, or any combination thereof. In some cases, the connection status indicator 318 outputs a signal exclusively when the oximetry sensor 312 is disconnected from the medical device, and refrains from outputting the signal when the oximetry sensor 312 is connected with the medical device. In some examples, the connection status indicator 318 outputs a first signal when the oximetry sensor 312 is disconnected from the medical device, and outputs a second signal when the oximetry sensor 312 is connected to the medical device. For instance, the first and second signals may have different frequencies, durations, pulse patterns, periods, colors, tones, intensities, or any combination thereof.

In some cases, the circuitry within the oximetry sensor 312 (e.g., the light source(s) and light sensor(s) and the connection status indicator 318 are connected to a power source of the oximetry sensor 312, such as when the oximetry sensor 312 is disconnected from the medical device. In some examples, the circuitry and the connection status indicator 318 are electrically connected to a power source in the medical device when the oximetry sensor 312 is connected with the medical device. Thus, the circuitry in the oximetry sensor 312 and/or the connection status indicator 318 may be powered regardless of whether the oximetry sensor 312 is connected to the medical device.

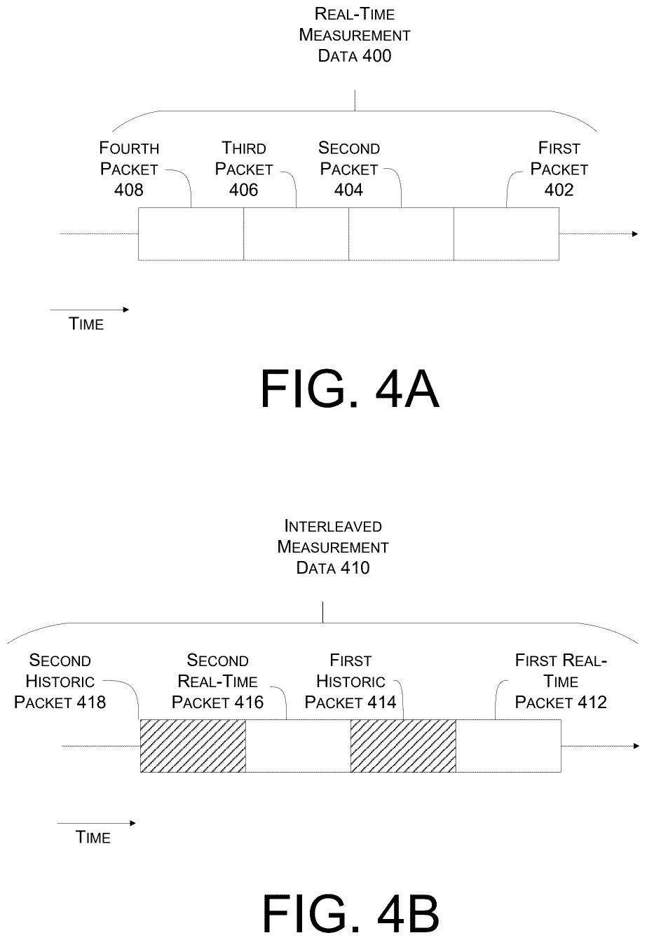

FIGS. 4A and 4B illustrate examples of measurement data transmitted by an accessory device to a medical device. For example, the examples of measurement data illustrated in FIGS. 4A and 4B correspond to the measurement data 126 described above, in some implementations.

FIG. 4A illustrates an example of real-time measurement data 400. In various cases, an accessory device is configured to detect a physiological parameter of a subject, such as using a sensor. The accessory device may take multiple measurements of the physiological parameter over time. For instance, the accessory device may sample the physiological parameter over multiple consecutive time periods, such as at a sampling rate.

The real-time measurement data 400, for instance, includes consecutive data packets that respectively include data indicating measurements of the physiological parameter in the consecutive time periods. For instance, a first packet 402 includes data representing a first measurement of the physiological parameter during a first time period, a second packet 404 includes data representing a second measurement of the physiological parameter during a second time period, a third packet 406 includes data representing a third measurement of the physiological parameter during a third time period, and a fourth packet 408 includes data representing a fourth measurement of the physiological parameter during a fourth time period. The first time period occurs before the second time period, the second time period occurs before the third time period, and the third time period occurs before the fourth time period, for instance.

The data packets of the real-time measurement data 400 are transmitted consecutively as the measurements are being generated by the accessory device. For instance, the first packet 402 is transmitted before the second packet 404, the second packet 404 is transmitted before the third packet 406, and the third packet 406 is transmitted before the fourth packet 408. Thus, the physiological parameter measurements in the real-time measurement data 400 are received by the medical device in order of detection.

FIG. 4B illustrates an example of interleaved measurement data 410. In various cases, the accessory device is temporarily disconnected from the medical device while still measuring the physiological parameter. Due to the disconnected status of the accessory device, the accessory device may be temporarily unable to transmit the measurement data generated while the accessory device is disconnected in real-time. In some cases, the accessory device is configured to temporarily store the measurement data generated while the accessory device is disconnected.

When the accessory device is reconnected to the medical device, the accessory device may be configured to transmit the stored measurement data. For instance, the accessory device transmits a first historic packet 414 and a second historic packet 418 representing the physiological parameter measurements obtained when the accessory device was disconnected from the medical device. In various cases, the accessory device continues to generate new measurement data when the accessory device is connected with the medical device. In some examples, the first historic packet 414 represents a measurement of the physiological parameter obtained during a first time period and the second historic packet 418 represents a measurement of the physiological parameter obtained during a second time period, wherein the first time period occurs before the second time period and both the first and second time periods occur when the accessory device is disconnected from the medical device. Accordingly, the accessory device transmits a first real-time packet 412 and a second real-time packet 416 representing the physiological parameter measurements obtained when the accessory device is connected to the medical device. In some cases, the first real-time packet 412 represents a measurement of the physiological parameter obtained during a third time period, and the second real-time packet 416 represents a measurement of the physiological parameter obtained during a fourth time period, wherein the third time period is before the fourth time period and both the third and fourth time periods occur when the accessory device is connected to the medical device.

In various implementations, the first historic packet 414 and second historic packet 418 are interleaved with the first real-time packet 412 and the second real-time packet 416. For instance, the first real-time packet 412 is transmitted before the first historic packet 414, the first historic packet 414 is transmitted before the second real-time packet 416, and the second real-time packet 416 is transmitted before the second historic packet 418. Accordingly, the medical device may receive the measurements of the physiological parameter obtained when the accessory device was disconnected from the medical device without significantly delaying the receipt of the real-time measurements that the accessory device obtains when the accessory device is connected to the medical device.

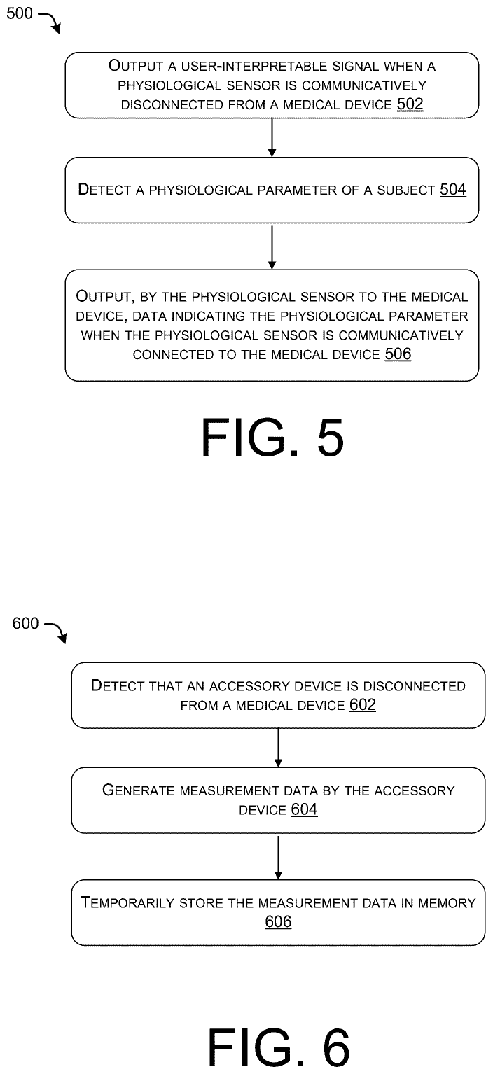

FIG. 5 illustrates an example process 500 for reporting a connection status and physiological parameter detected by an accessory device when the accessory device is disconnected from a medical device. In various cases, the process 500 is performed by an entity including the accessory device 102, the electrode pads 110, the hub 118, the plug 114, the cable 116, the cable 124, the connection status indicator 128, the accessory device 202, the electrode pad 300, the oximetry sensor 312, a medical device, a computing device, at least one processor, or any combination thereof.

At 502, the entity outputs a user-interpretable signal when a physiological sensor is communicatively disconnected from a medical device. In various cases, the physiological sensor is an accessory device configured to be removably coupled to the medical device. For instance, the accessory device includes a cable and a plug configured to be physically coupled with a port of the medical device. The physiological sensor, for instance, includes an electrode, a blood flow sensor, an airway sensor (e.g., an airway flow sensor and/or an airway pressure sensor), a capnography sensor, an oximetry sensor, a blood pressure sensor; a temperature sensor, a pulse sensor, a motion sensor, or a chemical sensor. The physiological sensor is configured to detect at least one physiological parameter from a subject. The physiological sensor is at least partially enclosed by a housing, for instance. In various cases, the housing is physically coupled to the physiological sensor. In various cases, the physiological sensor temporarily stores data indicative of the physiological parameter(s) when the physiological sensor is communicatively disconnected from the medical device.

A connection status indicator is configured to output the user-interpretable signal. In various cases, the connection status indicator includes a light source and the user-interpretable signal includes light. In some examples, the connection status indicator includes a speaker and the user-interpretable signal includes sound. When the physiological sensor is communicatively disconnected from the medical device, the user-interpretable signal may be a first user-interpretable signal having a first modality (e.g., light or sound), frequency, intensity, or pulse pattern. The connection status indicator, for instance, is physically coupled with the housing of the physiological sensor.

According to some examples, a connection sensor is configured to detect when the physiological sensor is communicatively disconnected from the medical device. According to some implementations, the connection sensor is configured to output an activation signal (e.g., an electrical signal) to the connection status indicator that causes the connection status indicator to output the user-interpretable signal. In some cases, the activation signal is a voltage that is used by a circuit in the connection status indicator to output the user-interpretable signal. In some cases, the connection sensor includes a requester including a signal generator configured to transmit an echo request to the medical device and a signal receiver configured to receive, from the medical device, an echo reply. For instance, the connection sensor may detect that the physiological sensor is disconnected from the medical device by determining that the echo reply has not been received within a threshold amount of time after transmitting the echo request. In some implementations, the requester transmits the echo request over the cable and/or a wireless interface with the medical device. According to some cases, the connection sensor includes an electrical sensor configured to detect whether an electrical signal (e.g., a voltage) has been received from the medical device over the cable.

At 504, the entity detects a physiological parameter of a subject. According to some cases, the entity uses an on-board power source of the physiological sensor when the physiological sensor has been disconnected from the medical device. In some implementations, the entity stores data representing measurements of the physiological parameter in memory. For instance, the memory is part of the physiological sensor.

At 506, the entity outputs, by the physiological sensor to the medical device, data indicating the physiological parameter when the physiological sensor is communicatively connected to the medical device. According to some cases, the connection sensor detects when the physiological sensor has been connected with the medical device. In response, the memory may output the data indicating the physiological parameter measurements that were obtained when the physiological sensor was disconnected from the medical device. According to some cases, the connection sensor may further output an activation signal to the connection status indicator that causes the connection status indicator to output a second user-interpretable signal. The second user-interpretable signal may indicate that the physiological sensor is connected with the medical device and may have a second modality, frequency, intensity, or pulse pattern. For instance, the second user-interpretable signal is different than the first user-interpretable signal.

FIG. 6 illustrates an example process 600 for temporarily storing measurement data in memory when an accessory device is disconnected from a medical device. In various cases, the process 600 is performed by an entity including the accessory device 102, the electrode pads 110, the hub 118, the plug 114, the cable 116, the cable 124, the connection status indicator 128, the accessory device 202, the electrode pad 300, the oximetry sensor 312, a medical device, a computing device, at least one processor, or any combination thereof.

At 602, the entity detects that an accessory device is disconnected from a medical device. In various cases, the accessory device is a physiological sensor. For instance, the accessory device may be an electrode, a blood flow sensor, an airway sensor, a capnography sensor, an oximetry sensor, a blood pressure sensor; a temperature sensor, a pulse sensor, a motion sensor, or a chemical sensor. In some implementations, the accessory device is a treatment device that enables the medical device to administer a treatment to a subject.

According to some examples, the accessory device is configured to be physically coupled with the medical device via a cable and a plug. In some examples, a connection sensor is configured to detect that the accessory device is electrically connected with the medical device by the plug and the cable. In some cases, the connection sensor includes a signal generator configured to transmit an echo request to the medical device, as well as a signal receiver configured to receive an echo reply from the medical device. If the medical device is not connected to the accessory device, then the connection sensor may refrain from detecting the echo reply within a threshold time period after transmitting the echo request. In some examples, the connection sensor includes an electrical sensor configured to detect the connection between the accessory device and the medical device by detecting an electrical signal (e.g., a voltage or current) from the medical device via the plug and cable.

At 604, the entity generates measurement data by the accessory device. For example, the accessory device includes a sensor configured to generate the measurement data by detecting a physical signal from a subject. In various implementations, the physical signal is detected by the sensor when the accessory device is disconnected to the medical device. The measurement data, for instance, includes measurements of a physiological parameter of the subject based on the detected physical signal. The physical signal and/or physiological parameter may be sampled at a sampling rate. In some cases, the sensor is physically adhered to the subject.

At 606, the entity temporarily stores the measurement data in memory. In various cases, the memory is part of the accessory device. In some cases, the entity additionally stores an indication of the time at which the accessory device was detected to have been disconnected from the medical device. In various implementations, the memory outputs the measurement data when the accessory device has been reconnected with the medical device. In some cases, the measurement data is transmitted to the medical device via the plug and cable and/or via a wireless interface.

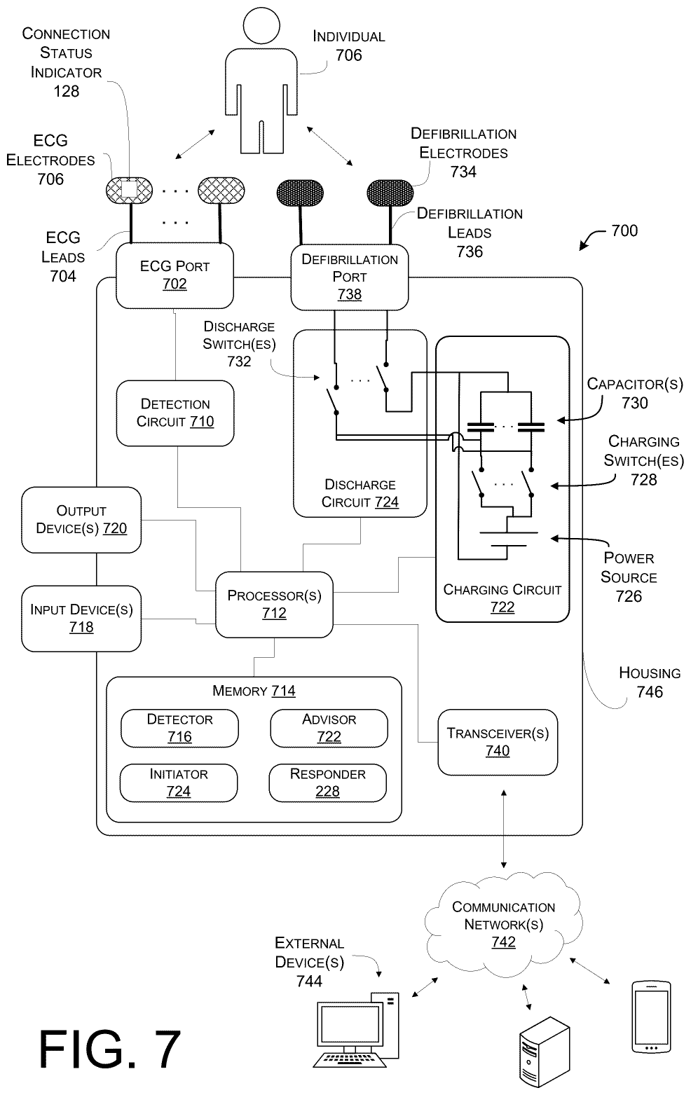

FIG. 7 illustrates an example of an external defibrillator 700 configured to perform various functions described herein. For example, the external defibrillator 700 is the medical device 106 described above with reference to FIG. 1 and/or the medical device 204 described above with reference to FIG. 2.

The external defibrillator 700 includes an electrocardiogram (ECG) port 702 connected to multiple ECG wires 704. In some cases, the ECG wires 704 are removeable from the ECG port 702. For instance, the ECG wires 704 are plugged into the ECG port 702 via connectors. The ECG wires 704 are connected to ECG electrodes 706, respectively. In various implementations, the ECG electrodes 706 are disposed on different locations on an individual 708. A detection circuit 710 is configured to detect relative voltages between the ECG electrodes 706. These voltages are indicative of the electrical activity of the heart of the individual 708.

In various implementations, the ECG electrodes 706 are in contact with the different locations on the skin of the individual 708. In some examples, a first one of the ECG electrodes 706 is placed on the skin between the heart and right arm of the individual 708, a second one of the ECG electrodes 706 is placed on the skin between the heart and left arm of the individual 708, and a third one of the ECG electrodes 706 is placed on the skin between the heart and a leg (either the left leg or the right leg) of the individual 708. In these examples, the detection circuit 710 is configured to measure the relative voltages between the first, second, and third ECG electrodes 706. Respective pairings of the ECG electrodes 706 are referred to as “leads,” and the voltages between the pairs of ECG electrodes 706 are known as “lead voltages.” In some examples, more than three ECG electrodes 706 are included, such that 5-lead or 12-lead ECG signals are detected by the detection circuit 710. In various implementations, the ECG electrodes 706 include the connection status indicator 128. For instance, the ECG electrodes 706 may include various elements and functionality of the accessory device 102 and/or accessory device 202.

The detection circuit 710 includes at least one analog circuit, at least one digital circuit, or a combination thereof. The detection circuit 710 receives the analog electrical signals from the ECG electrodes 706, via the ECG port 702 and the ECG wires 704. In some cases, the detection circuit 710 includes one or more analog filters configured to filter noise and/or artifact from the electrical signals. The detection circuit 710 includes an analog-to-digital (ADC) in various examples. The detection circuit 710 generates a digital signal indicative of the analog electrical signals from the ECG electrodes 706. This digital signal can be referred to as an “ECG signal” or an “ECG.”

In some cases, the detection circuit 710 further detects an electrical impedance between at least one pair of the ECG electrodes 706. For example, the detection circuit 710 includes, or otherwise controls, a power source that applies a known voltage (or current) across a pair of the ECG electrodes 706 and detects a resultant current (or voltage) between the pair of the ECG electrodes 706. The impedance is generated based on the applied signal (voltage or current) and the resultant signal (current or voltage). In various cases, the impedance corresponds to respiration of the individual 708, chest compressions performed on the individual 708, and other physiological states of the individual 708. In various examples, the detection circuit 710 includes one or more analog filters configured to filter noise and/or artifact from the resultant signal. The detection circuit 710 generates a digital signal indicative of the impedance using an ADC. This digital signal can be referred to as an “impedance signal” or an “impedance.”

The detection circuit 710 provides the ECG signal and/or the impedance signal one or more processors 712 in the external defibrillator 700. In some implementations, the processor(s) 712 includes a central processing unit (CPU), a graphics processing unit (GPU), both CPU and GPU, or other processing unit or component known in the art.

The processor(s) 712 is operably connected to memory 714. In various implementations, the memory 714 is volatile (such as random access memory (RAM)), non-volatile (such as read only memory (ROM), flash memory, etc.) or some combination of the two. The memory 714 stores instructions that, when executed by the processor(s) 712, causes the processor(s) 712 to perform various operations. In various examples, the memory 714 stores methods, threads, processes, applications, objects, modules, any other sort of executable instruction, or a combination thereof. In some cases, the memory 714 stores files, databases, or a combination thereof. In some examples, the memory 714 includes, but is not limited to, RAM, ROM, electrically erasable programmable read-only memory (EEPROM), flash memory, or any other memory technology. In some examples, the memory 714 includes one or more of CD-ROMs, digital versatile discs (DVDs), content-addressable memory (CAM), or other optical storage, magnetic cassettes, magnetic tape, magnetic disk storage or other magnetic storage devices, or any other medium which can be used to store the desired information and which can be accessed by the processor(s) 712 and/or the external defibrillator 700. In some cases, the memory 714 at least temporarily stores the ECG signal and/or the impedance signal.

In various examples, the memory 714 includes a detector 716, which causes the processor(s) 712 to determine, based on the ECG signal and/or the impedance signal, whether the individual 708 is exhibiting a particular heart rhythm. For instance, the processor(s) 712 determines whether the individual 708 is experiencing a shockable rhythm that is treatable by defibrillation. Examples of shockable rhythms include ventricular fibrillation (VF) and ventricular tachycardia (V-Tach). In some examples, the processor(s) 712 determines whether any of a variety of different rhythms (e.g., asystole, sinus rhythm, atrial fibrillation (AF), etc.) are present in the ECG signal.

The processor(s) 712 is operably connected to one or more input devices 718 and one or more output devices 720. Collectively, the input device(s) 718 and the output device(s) 720 function as an interface between a user and the defibrillator 700. The input device(s) 718 is configured to receive an input from a user and includes at least one of a keypad, a cursor control, a touch-sensitive display, a voice input device (e.g., a microphone), a haptic feedback device (e.g., a gyroscope), or any combination thereof. The output device(s) 720 includes at least one of a display, a speaker, a haptic output device, a printer, or any combination thereof. In various examples, the processor(s) 712 causes a display among the input device(s) 718 to visually output a waveform of the ECG signal and/or the impedance signal. In some implementations, the input device(s) 718 includes one or more touch sensors, the output device(s) 720 includes a display screen, and the touch sensor(s) are integrated with the display screen. Thus, in some cases, the external defibrillator 700 includes a touchscreen configured to receive user input signal(s) and visually output physiological parameters, such as the ECG signal and/or the impedance signal.

In some examples, the memory 714 includes an advisor 722, which, when executed by the processor(s) 712, causes the processor(s) 712 to generate advice and/or control the output device(s) 720 to output the advice to a user (e.g., a rescuer). In some examples, the processor(s) 712 provides, or causes the output device(s) 720 to provide, an instruction to perform CPR on the individual 708. In some cases, the processor(s) 712 evaluates, based on the ECG signal, the impedance signal, or other physiological parameters, CPR being performed on the individual 708 and causes the output device(s) 720 to provide feedback about the CPR in the instruction. According to some examples, the processor(s) 712, upon identifying that a shockable rhythm is present in the ECG signal, causes the output device(s) 720 to output an instruction and/or recommendation to administer a defibrillation shock to the individual 708.

The memory 714 also includes an initiator 724 which, when executed by the processor(s) 712, causes the processor(s) 712 to control other elements of the external defibrillator 700 in order to administer a defibrillation shock to the individual 708. In some examples, the processor(s) 712 executing the initiator 724 selectively causes the administration of the defibrillation shock based on determining that the individual 708 is exhibiting the shockable rhythm and/or based on an input from a user (received, e.g., by the input device(s) 718. In some cases, the processor(s) 712 causes the defibrillation shock to be output at a particular time, which is determined by the processor(s) 712 based on the ECG signal and/or the impedance signal. In some cases, the memory 714 further includes the responder 228.

The processor(s) 712 is operably connected to a charging circuit 723 and a discharge circuit 725. In various implementations, the charging circuit 723 includes a power source 726, one or more charging switches 728, and one or more capacitors 730. The power source 726 includes, for instance, a battery. The processor(s) 712 initiates a defibrillation shock by causing the power source 726 to charge at least one capacitor among the capacitor(s) 730. For example, the processor(s) 712 activates at least one of the charging switch(es) 728 in the charging circuit 723 to complete a first circuit connecting the power source 726 and the capacitor to be charged. Then, the processor(s) 712 causes the discharge circuit 725 to discharge energy stored in the charged capacitor across a pair of defibrillation electrodes 734, which are in contact with the individual 708. For example, the processor(s) 712 deactivates the charging switch(es) 728 completing the first circuit between the capacitor(s) 730 and the power source 726, and activates one or more discharge switches 732 completing a second circuit connecting the charged capacitor 730 and at least a portion of the individual 708 disposed between defibrillation electrodes 734.

The energy is discharged from the defibrillation electrodes 734 in the form of a defibrillation shock. For example, the defibrillation electrodes 734 are connected to the skin of the individual 708 and located at positions on different sides of the heart of the individual 708, such that the defibrillation shock is applied across the heart of the individual 708. The defibrillation shock, in various examples, depolarizes a significant number of heart cells in a short amount of time. The defibrillation shock, for example, interrupts the propagation of the shockable rhythm (e.g., VF or V-Tach) through the heart. In some examples, the defibrillation shock is 200 J or greater with a duration of about 0.015 seconds. In some cases, the defibrillation shock has a multiphasic (e.g., biphasic) waveform. The discharge switch(es) 732 are controlled by the processor(s) 712, for example. In various implementations, the defibrillation electrodes 734 are connected to defibrillation leads 736. The defibrillation wires 736 are connected to a defibrillation port 738, in implementations. According to various examples, the defibrillation wires 736 are removable from the defibrillation port 738. For example, the defibrillation wires 736 are plugged into the defibrillation port 738.

In various implementations, the processor(s) 712 is operably connected to one or more transceivers 740 that transmit and/or receive data over one or more communication networks 742. For example, the transceiver(s) 740 includes a network interface card (NIC), a network adapter, a local area network (LAN) adapter, or a physical, virtual, or logical address to connect to the various external devices and/or systems. In various examples, the transceiver(s) 740 includes any sort of wireless transceivers capable of engaging in wireless communication (e.g., radio frequency (RF) communication). For example, the communication network(s) 742 includes one or more wireless networks that include a 3^{rd} Generation Partnership Project (3GPP) network, such as a Long Term Evolution (LTE) radio access network (RAN) (e.g., over one or more LTE bands), a New Radio (NR) RAN (e.g., over one or more NR bands), or a combination thereof. In some cases, the transceiver(s) 740 includes other wireless modems, such as a modem for engaging in WI-FI®, WIGIG®, WIMAX®, BLUETOOTH®, or infrared communication over the communication network(s) 742.

The defibrillator 700 is configured to transmit and/or receive data (e.g., ECG data, impedance data, data indicative of one or more detected heart rhythms of the individual 708, data indicative of one or more defibrillation shocks administered to the individual 708, etc.) with one or more external devices 744 via the communication network(s) 742. The external devices 744 include, for instance, mobile devices (e.g., mobile phones, smart watches, etc.), Internet of

Things (IoT) devices, medical devices, computers (e.g., laptop devices, servers, etc.), or any other type of computing device configured to communicate over the communication network(s) 742. In some examples, the external device(s) 744 is located remotely from the defibrillator 700, such as at a remote clinical environment (e.g., a hospital). According to various implementations, the processor(s) 712 causes the transceiver(s) 740 to transmit data to the external device(s) 744. In some cases, the transceiver(s) 740 receives data from the external device(s) 744 and the transceiver(s) 740 provide the received data to the processor(s) 712 for further analysis.

In various implementations, the external defibrillator 700 also includes a housing 746 that at least partially encloses other elements of the external defibrillator 700. For example, the housing 746 encloses the detection circuit 710, the processor(s) 712, the memory 714, the charging circuit 723, the transceiver(s) 740, or any combination thereof. In some cases, the input device(s) 718 and output device(s) 720 extend from an interior space at least partially surrounded by the housing 746 through a wall of the housing 746. In various examples, the housing 746 acts as a barrier to moisture, electrical interference, and/or dust, thereby protecting various components in the external defibrillator 700 from damage.

In some implementations, the external defibrillator 700 is an automated external defibrillator (AED) operated by an untrained user (e.g., a bystander, layperson, etc.) and can be operated in an automatic mode. In automatic mode, the processor(s) 712 automatically identifies a rhythm in the ECG signal, makes a decision whether to administer a defibrillation shock, charges the capacitor(s) 730, discharges the capacitor(s) 730, or any combination thereof. In some cases, the processor(s) 712 controls the output device(s) 720 to output (e.g., display) a simplified user interface to the untrained user. For example, the processor(s) 712 refrains from causing the output device(s) 720 to display a waveform of the ECG signal and/or the impedance signal to the untrained user, in order to simplify operation of the external defibrillator 700.

In some examples, the external defibrillator 700 is a monitor-defibrillator utilized by a trained user (e.g., a clinician, an emergency responder, etc.) and can be operated in a manual mode or the automatic mode. When the external defibrillator 700 operates in manual mode, the processor(s) 712 cause the output device(s) 720 to display a variety of information that may be relevant to the trained user, such as waveforms indicating the ECG data and/or impedance data, notifications about detected heart rhythms, and the like.

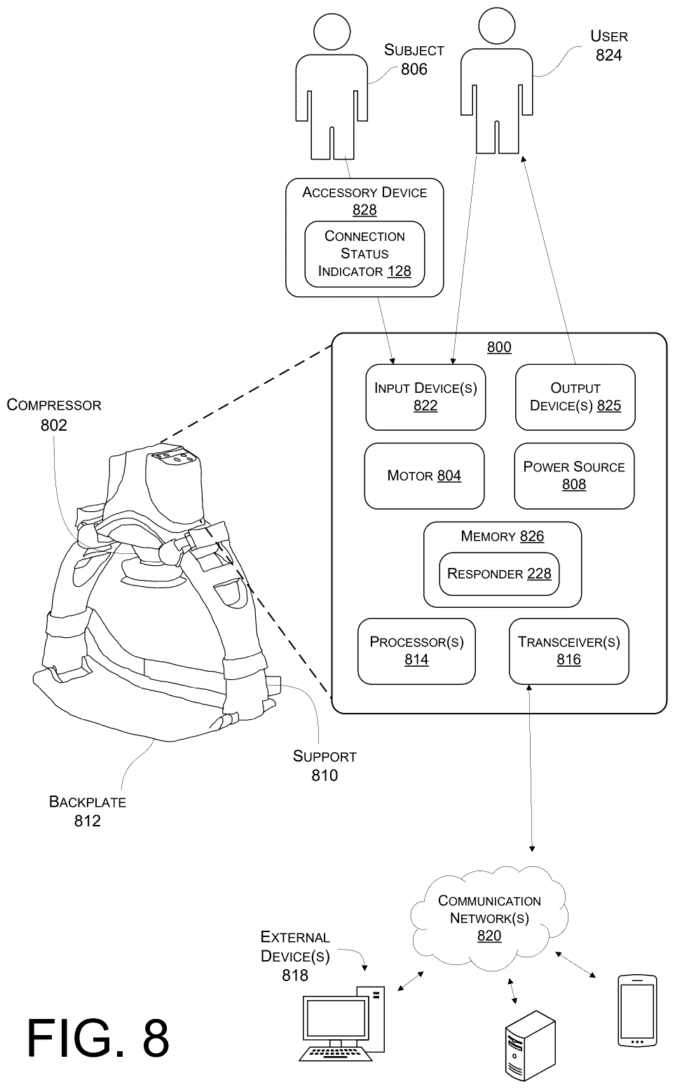

FIG. 8 illustrates a chest compression device 800 configured to perform various functions described herein. For example, the chest compression device 800 is the medical device 204 described in FIG. 2.

In various implementations, the chest compression device 800 includes a compressor 802 that is operatively coupled to a motor 804. The compressor 802 physically administers a force to the chest of a subject 806 that compresses the chest of the subject 806. In some examples, the compressor 802 includes at least one piston that periodically moves between two positions (e.g., a compressed position and a release position) at a compression frequency. For example, when the piston is positioned on the chest of the subject 806, the piston compresses the chest when the piston is moved into the compressed position. A suction cup may be positioned on a tip of the piston, such that the suction cup contacts the chest of the subject 806 during operation. In various cases, the compressor 802 includes a band that periodically tightens to a first tension and loosens to a second tension at a compression frequency. For instance, when the band is disposed around the chest of the subject 806, the band compresses the chest when the band tightens.

The motor 804 is configured to convert electrical energy stored in a power source 808 into mechanical energy that moves and/or tightens the compressor 802, thereby causing the compressor 802 to administer the force to the chest of the subject 806. In various implementations, the power source 808 is portable. For instance, the power source 808 includes at least one rechargeable (e.g., lithium-ion) battery. In some cases, the power source 808 supplies electrical energy to one or more elements of the chest compression device 800 described herein.

In various cases, the chest compression device 800 includes a support 810 that is physically coupled to the compressor 802, such that the compressor 802 maintains a position relative to the subject 806 during operation. In some implementations, the support 810 is physically coupled to a backplate 812, cot, or other external structure with a fixed position relative to the subject 806. According to some cases, the support 810 is physically coupled to a portion of the subject 806, such as wrists of the subject 806.

The operation of the chest compression device 800 may be controlled by at least one processor 814. In various implementations, the motor 804 is communicatively coupled to the processor(s) 814. Specifically, the processor(s) 814 is configured to output a control signal to the motor 804 that causes the motor 804 to actuate the compressor 802. For instance, the motor 804 causes the compressor 802 to administer the compressions to the subject 806 based on the control signal. In some cases, the control signal indicates one or more treatment parameters of the compressions. Examples of treatment parameters include a frequency, timing, depth, force, position, velocity, and acceleration of the compressor 802 administering the compressions. According to various cases, the control signal causes the motor 804 to cease compressions.

In various implementations, the chest compression device 800 includes at least one transceiver 816 configured to communicate with at least one external device 818 over one or more communication networks 820. Any communication network described herein can be included in the communication network(s) 820 illustrated in FIG. 8. The external device(s) 818, for example, includes at least one of a monitor-defibrillator, an AED, an ECMO device, a ventilation device, a patient monitor, a mobile phone, a server, or a computing device. In some implementations, the transceiver(s) 816 is configured to communicate with the external device(s) 818 by transmitting and/or receiving signals wirelessly. For example, the transceiver(s) 816 includes a NIC, a network adapter, a LAN adapter, or a physical, virtual, or logical address to connect to the various external devices and/or systems. In various examples, the transceiver(s) 816 includes any sort of wireless transceivers capable of engaging in wireless communication (e.g., RF communication). For example, the communication network(s) 820 includes one or more wireless networks that include a 3GPP network, such as an LTE RAN (e.g., over one or more LTE bands), an NR RAN (e.g., over one or more NR bands), or a combination thereof. In some cases, the transceiver(s) 816 includes other wireless modems, such as a modem for engaging in WI-FI®, WIGIG®, WIMAX®, BLUETOOTH®, or infrared communication over the communication network(s) 820. The signals, in various cases, encode data in the form of data packets, datagrams, or the like. In some cases, the signals are transmitted as compressions are being administered by the chest compression device 800 (e.g., for real-time feedback by the external device(s) 818), after compressions are administered by the chest compression device 800 (e.g., for post-event review at the external device 818), or a combination thereof.

In various cases, the processor(s) 814 generates the control signal based on data encoded in the signals received from the external device(s) 818. For instance, the signals include an instruction to initiate the compressions, and the processor(s) 814 instructs the motor 804 to begin actuating the compressor 802 in accordance with the signals.

In some cases, the chest compression device 800 includes at least one input device 822. In various examples, the input device(s) 822 is configured to receive an input signal from a user 824, who may be a rescuer treating the subject 806. Examples of the input device(s) 822 include, for instance, at a keypad, a cursor control, a touch-sensitive display, a voice input device (e.g., a microphone), a haptic feedback device (e.g., a gyroscope), or any combination thereof. In various implementations, the processor(s) 814 generate the control signal based on the input signal. For instance, the processor(s) 814 generate the control signal to adjust a frequency of the compressions based on the chest compression device 800 detecting a selection by the user 824 of a user interface element displayed on a touchscreen or detecting the user 824 pressing a button integrated with an external housing of the chest compression device 800.

According to some examples, the input device(s) 822 include one or more sensors. The sensor(s), for example, is configured to detect a physiological parameter of the subject 806. In some implementations, the sensor(s) is configured to detect a state parameter of the chest compression device 800, such as a position of the compressor 802 with respect to the subject 806 or the backplate 812, a force administered by the compressor 802 on the subject 806, a force administered onto the backplate 812 by the body of the subject 806 during a compression, or the like. According to some implementations, the signals transmitted by the transceiver(s) 816 indicate the physiological parameter(s) and/or the state parameter(s).

The chest compression device 800 further includes at least one output device 825, in various implementations. Examples of the output device(s) 825 include, for instance, least one of a display (e.g., a projector, an LED screen, etc.), a speaker, a haptic output device, a printer, or any combination thereof. In some implementations, the output device(s) 825 include a screen configured to display various parameters detected by and/or reported to the chest compression device 800, a charge level of the power source 808, a timer indicating a time since compressions were initiated or paused, and other relevant information.

The chest compression device 800 further includes memory 826. In various implementations, the memory 826 is volatile (such as random access memory (RAM)), non-volatile (such as read only memory (ROM), flash memory, etc.) or some combination of the two. The memory 826 stores instructions that, when executed by the processor(s) 814, causes the processor(s) 814 to perform various operations. In various examples, the memory 826 stores methods, threads, processes, applications, objects, modules, any other sort of executable instruction, or a combination thereof. In some cases, the memory 826 stores files, databases, or a combination thereof. In some examples, the memory 826 includes, but is not limited to, RAM, ROM, EEPROM, flash memory, or any other memory technology. In some examples, the memory 826 includes one or more of CD-ROMs, DVDs, CAM, or other optical storage, magnetic cassettes, magnetic tape, magnetic disk storage or other magnetic storage devices, or any other medium which can be used to store the desired information. In various cases, the memory 826 stores instructions, programs, threads, objects, data, or any combination thereof, that cause the processor(s) 814 to perform various functions. In various cases, the memory 826 stores one or more parameters that are detected by the chest compression device 800 and/or reported to the chest compression device 800. In some cases, the memory 826 includes the responder 228.

In implementations of the present disclosure, an accessory device 828 is removably connected to the chest compression device 800. In some cases, the accessory device 828 is configured to output a signal indicating whether it is connected to the chest compression device 800 via the connection status indicator 128.

### EXAMPLE CLAUSES

1. A system, including: a monitor-defibrillator including a port; and a medical device accessory, including: an electrocardiogram (ECG) electrode configured to be adhered to skin of a subject; a substrate physically coupled to the ECG electrode; a plug configured to be removably coupled with the port of the monitor-defibrillator; a cable electrically connected to the ECG electrode and the plug; and a light source physically mounted on the substrate, the light source being configured to: emit light having a first color or pulse pattern when the ECG electrode is electrically connected with the monitor-defibrillator by the plug and the cable; and emit light having a second color or a second pulse pattern when the ECG electrode is electrically disconnected from the monitor-defibrillator.

2. The system of clause 1, wherein the medical device accessory further includes: a power source configured to supply power to the light source when the ECG electrode is electrically disconnected from the monitor-defibrillator.

3. The system of clause 1 or 2, wherein the medical device accessory further includes: a transceiver configured to transmit, to the monitor-defibrillator when the ECG electrode is electrically disconnected from the monitor-defibrillator, first data indicating an ECG of the subject, wherein the cable is configured to transmit second data indicating the ECG of the subject to the monitor-defibrillator when the ECG electrode is electrically connected to the monitor-defibrillator; and wherein the monitor-defibrillator includes a display configured to visually present the ECG.

4. A medical device accessory, including: a physiological sensor configured to detect a physiological parameter; a housing physically coupled to the physiological sensor; a plug configured to be removably coupled with a medical device; a cable electrically connected to the physiological sensor and the plug; and a connection status indicator physically coupled with the housing and configured to output a user-interpretable signal when the physiological sensor is electrically connected with the medical device by the plug and the cable.

5. The medical device accessory of clause 4, wherein the physiological sensor includes an electrode, a blood flow sensor, an airway sensor, a capnography sensor, an oximetry sensor, a blood pressure sensor; a temperature sensor, a pulse sensor, a motion sensor, or a chemical sensor.

6. The medical device accessory of clause 4 or 5, wherein the housing encloses the physiological sensor.

7. The medical device of any of clauses 4 to 6, wherein the connection status indicator includes a light source, and wherein the user-interpretable signal includes light.

8. The medical device accessory of any of clauses 4 to 7, wherein the connection status indicator includes a speaker, and wherein the user-interpretable signal includes sound.

9. The medical device accessory any of clauses 4 to 8, the user-interpretable signal being a first user-interpretable signal, wherein the connection status indicator is further configured to output a second user-interpretable signal when the physiological sensor is disconnected from the medical device, the second user-interpretable signal having a different modality, frequency, intensity, or pulse pattern than the first user-interpretable signal.

10. The medical device accessory of clause 9, further including: memory configured to store measurement data generated by the physiological sensor in response to the physiological sensor being disconnected from the medical device.

11. The medical device accessory of any of clauses 4 to 10, further including: a connection sensor configured to: detect that the physiological sensor is electrically connected with the medical device by the plug and the cable, and in response to detecting that the physiological sensor is electrically connected with the medical device by the plug and the cable, output an activation signal to the connection status indicator, wherein the connection status indicator is configured to output the user-interpretable signal in response to receiving the activation signal.

12. The medical device accessory of clause 11, wherein the connection sensor includes: a signal generator configured to transmit an echo request over the cable toward the medical device; and a signal receiver configured to receive, over the cable from the medical device, an echo reply, and wherein the signal generator is further configured to generate the activation signal in response to the signal receiver receiving the echo reply.

13. The medical device accessory of clause 11 or 12, wherein the connection sensor includes an electrical sensor configured to detect that the physiological sensor is electrically connected with the medical device by the plug and the cable by detecting an electrical signal from the plug and the cable.

14. A method, including: outputting, by a connection status indicator disposed on a physiological sensor, a user-interpretable signal when the physiological sensor is communicatively disconnected from a medical device; detecting, by the physiological sensor, a physiological parameter of a subject; and outputting, by the physiological sensor to the medical device, data indicating the physiological parameter when the physiological sensor is communicatively connected to the medical device.

15. The method of clause 14, wherein the physiological parameter includes an electrocardiogram (ECG), a blood flow parameter, an airway parameter, a capnograph, a partial pressure of CO₂, a partial pressure of O₂, a blood oxygenation, a blood pressure, a temperature, a pulse, an acceleration, or a concentration of a chemical.

16. The method of clause 14 or 15, wherein the connection status indicator includes a light source, and wherein the user-interpretable signal includes light.

17. The method of any of clauses 14 to 16, wherein the connection status indicator includes a speaker, and wherein the user-interpretable signal includes sound.

18. The method of any of clauses 14 to 17, the user-interpretable signal being a first user-interpretable signal, the method further including: outputting, by the connection status indicator, a second user-interpretable signal when the physiological sensor is connected to the medical device, the second user-interpretable signal having a different modality, frequency, intensity, or pulse pattern than the first user-interpretable signal.

19. The method of any of clauses 14 to 18, the data being first data, the method further including: storing, in memory, second data indicating the physiological parameter when the physiological sensor is disconnected from the medical device.

20. The method of clause 19, further including: outputting, by the physiological sensor to the medical device, the second data when the physiological sensor is communicatively connected to the medical device.

21. A system, including: a medical device including a port; and an electrocardiogram (ECG) sensor accessory including: a plug configured to be removably connected to the medical device; a cable connected to the plug; a battery; an ECG sensor connected to the cable during a first time period and disconnected from the cable during a second time period, the ECG sensor including: a first electrode configured to be adhered to a subject; a second electrode configured to be adhered to the subject; memory; a circuit communicatively coupled to the cable and the memory and configured to: draw first power from the medical device via the cable during the first time period; output, to the medical device via the cable, first data indicating a relative electrical potential between the first electrode and the second electrode during the first time period; draw second power from the battery during the second time period; and cause the memory to store second data indicating a relative electrical potential between the first electrode and the second electrode during the second time period.

22. The system of clause 21, wherein the circuit is further configured to: draw third power from the medical device via the cable during a third time period, the ECG sensor being connected to the cable during the third time period, the third time period occurring after the second time period; and output, to the medical device via the cable, third data interleaved with the second data, the third data indicating a relative electrical potential between the first electrode and the second electrode during the third time period.

23. The system of clause 21 or 22, wherein the ECG sensor further includes: an electrically insulative substrate disposed on the first electrode or the second electrode; and a light source disposed on the electrically insulative substrate, the light source being configured to: draw third power from the battery during the second time period; and output light during the second time period.

24. A medical device accessory, including: a plug configured to be removably connected to a medical device; a cable connected to the plug; a power source; a sensor connected to the cable during a first time period and disconnected from the cable during a second time period, the sensor being configured to: receive power from the power source during the second time period; generate first measurement data by detecting a physical signal during the first time period; and generate second measurement data by detecting the physical signal during the second time period; and memory communicatively coupled with the sensor and configured to store the second measurement data.

25. The medical device accessory of clause 24, wherein the sensor is further connected to the cable during a third time period that occurs after the second time period, and wherein the memory is configured to output the second measurement data during the third time period.

26. The medical device accessory of clause 25, wherein the memory is configured to output the second measurement data during the third time period to the medical device or to another medical device.

27. The medical device accessory of clause 25 or 26, wherein the sensor is further configured to generate a stream of third measurement data by detecting the physical signal during the third time period, and wherein the cable transmits, to the plug, the second measurement data interleaved with the third measurement data during the third time period.

28. The medical device accessory of any of clauses 24 to 27, further including: a transceiver configured to receive power from the power source and to transmit, to the medical device over a wireless interface, a communication signal indicating the second measurement data.

29. The medical device accessory of any of clauses 24 to 28, wherein the sensor includes an electrode, a blood flow sensor, an airway pressure sensor, an airway flow sensor, a capnography sensor, an oximetry sensor, a blood pressure sensor; a temperature sensor, a pulse sensor, a motion sensor, or a chemical sensor.

30. The medical device accessory of any of clauses 24 to 29, wherein the sensor is physically adhered to a subject.

31. The medical device accessory of any of clauses 24 to 30, wherein the power source includes: a battery or capacitor configured to store power; and an antenna configured to charge the battery or capacitor in response to receiving an electromagnetic signal.

32. The medical device accessory of any of clauses 24 to 31, further including: a light source physically coupled to a housing of the sensor and configured to receive power from the power source, the light source being configured to output light having a first color or pulse pattern when the sensor is electrically connected with the medical device by the plug and the cable and to output light having a second color or pulse pattern when the sensor is disconnected from the medical device.

33. A method, including: detecting that a cable is connected to a medical device during a first time period; generating, during the first time period, first measurement data by detecting a physical signal during the first time period; outputting, by the cable to the medical device during the first time period, the first measurement data; detecting that the cable is disconnected from the medical device during a second time period; generating, during the second time period, second measurement data by detecting the physical signal during the second time period; storing, in memory during the second time period, the second measurement data.

34. The method of clause 33, the medical device being a first medical device, the method further including: detecting that the cable is connected to the first medical device or to a second medical device during a third time period, the third time period occurring after the second time period; and outputting, by the cable during the third time period, the second measurement data.

35. The method of clause 34, further including: generating, during the third time period, third measurement data by detecting the physical signal during the third time period, wherein outputting, by the cable during the third time period, the second measurement data includes outputting a stream of data including the second measurement data interleaved with the third measurement data.

36. The method of any of clauses 33 to 35, further including: transmitting, by a transceiver to the medical device, a communication signal indicating the second measurement data.

37. The method of any of clauses 33 to 36, wherein the physical signal includes an electrical signal, light, sound, a pressure, a temperature, or a chemical signal.

38. The method of any of clauses 33 to 37, further including: receiving, by the cable during the first time period, first power from the medical device; and receiving, during the second time period, second power from an onboard power source, wherein generating the first measurement data is in response to receiving the first power from the medical device, and wherein generating the second measurement data is in response to receiving the second power from the onboard power source.

39. The method of clause 38, wherein the power source includes: a battery or capacitor configured to store the second power; and an antenna configured to charge the battery or capacitor in response to receiving an electromagnetic signal.

40. The method of any of clauses 33 to 39, further including: in response to detecting that the cable is disconnected from the medical device, outputting, by a light source, a light signal.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain implementations are described herein, including the best mode known to the inventors for carrying out implementations of the disclosure. Of course, variations on these described implementations will become apparent to those of ordinary skill in the art upon reading the foregoing description. The inventors expect skilled artisans to employ such variations as appropriate, and the inventors intend for implementations to be practiced otherwise than specifically described herein. Accordingly, the scope of this disclosure includes all modifications and equivalents of the subject matter recited in the claims appended hereto as permitted by applicable law. Moreover, any combination of the above-described elements in all possible variations thereof is encompassed by implementations of the disclosure unless otherwise indicated herein or otherwise clearly contradicted by context.

What is claimed is:

1. A system, comprising:
a monitor-defibrillator comprising a port; and
a medical device accessory, comprising:
an electrocardiogram (ECG) electrode configured to be adhered to skin of a subject;
a substrate physically coupled to the ECG electrode;
a plug configured to be removably coupled with the port of the monitor-defibrillator;
a cable electrically connected to the ECG electrode and the plug; and
a light source physically mounted on the substrate, the light source being configured to:
emit light having a first color or pulse pattern when the ECG electrode is electrically connected with the monitor-defibrillator by the plug and the cable; and
emit light having a second color or a second pulse pattern when the ECG electrode is electrically disconnected from the monitor-defibrillator.

2. The system of claim 1, wherein the medical device accessory further comprises:
a power source configured to supply power to the light source when the ECG electrode is electrically disconnected from the monitor-defibrillator.

3. The system of claim 1, wherein the medical device accessory further comprises:
a transceiver configured to transmit, to the monitor-defibrillator when the ECG electrode is electrically disconnected from the monitor-defibrillator, first data indicating an ECG of the subject,
wherein the cable is configured to transmit second data indicating the ECG of the subject to the monitor-defibrillator when the ECG electrode is electrically connected to the monitor-defibrillator; and
wherein the monitor-defibrillator comprises a display configured to visually present the ECG.

4. A medical device accessory, comprising:
a physiological sensor configured to detect a physiological parameter;
a housing physically coupled to the physiological sensor;
a plug configured to be removably coupled with a medical device;
a cable electrically connected to the physiological sensor and the plug; and
a connection status indicator physically coupled with the housing and configured to output a user-interpretable signal when the physiological sensor is electrically connected with the medical device by the plug and the cable.

5. The medical device accessory of claim 4, wherein the physiological sensor comprises an electrode, a blood flow sensor, an airway sensor, a capnography sensor, an oximetry sensor, a blood pressure sensor; a temperature sensor, a pulse sensor, a motion sensor, or a chemical sensor.

6. The medical device accessory of claim 4, wherein the housing encloses the physiological sensor.

7. The medical device of claim 4, wherein the connection status indicator comprises a light source, and
wherein the user-interpretable signal comprises light.

8. The medical device accessory of claim 4, wherein the connection status indicator comprises a speaker, and
wherein the user-interpretable signal comprises sound.

9. The medical device accessory of claim 4, the user-interpretable signal being a first user-interpretable signal, wherein the connection status indicator is further configured to output a second user-interpretable signal when the physiological sensor is disconnected from the medical device, the second user-interpretable signal having a different modality, frequency, intensity, or pulse pattern than the first user-interpretable signal.

10. The medical device accessory of claim 9, further comprising:
memory configured to store measurement data generated by the physiological sensor in response to the physiological sensor being disconnected from the medical device.

11. The medical device accessory of claim 4, further comprising:
a connection sensor configured to:
detect that the physiological sensor is electrically connected with the medical device by the plug and the cable, and
in response to detecting that the physiological sensor is electrically connected with the medical device by the plug and the cable, output an activation signal to the connection status indicator,
wherein the connection status indicator is configured to output the user-interpretable signal in response to receiving the activation signal.

12. The medical device accessory of claim 11, wherein the connection sensor comprises:
a signal generator configured to transmit an echo request over the cable toward the medical device; and
a signal receiver configured to receive, over the cable from the medical device, an echo reply, and
wherein the signal generator is further configured to generate the activation signal in response to the signal receiver receiving the echo reply.

13. The medical device accessory of claim 11, wherein the connection sensor comprises an electrical sensor configured to detect that the physiological sensor is electrically connected with the medical device by the plug and the cable by detecting an electrical signal from the plug and the cable.

14. A method, comprising:
outputting, by a connection status indicator disposed on a physiological sensor, a user-interpretable signal when the physiological sensor is communicatively disconnected from a medical device;
detecting, by the physiological sensor, a physiological parameter of a subject; and
outputting, by the physiological sensor to the medical device, data indicating the physiological parameter when the physiological sensor is communicatively connected to the medical device.

15. The method of claim 14, wherein the physiological parameter comprises an electrocardiogram (ECG), a blood flow parameter, an airway parameter, a capnograph, a partial pressure of CO₂, a partial pressure of O₂, a blood oxygenation, a blood pressure, a temperature, a pulse, an acceleration, or a concentration of a chemical.

16. The method of claim 14, wherein the connection status indicator comprises a light source, and
wherein the user-interpretable signal comprises light.

17. The method of claim 14, wherein the connection status indicator comprises a speaker, and
wherein the user-interpretable signal comprises sound.

18. The method of claim 14, the user-interpretable signal being a first user-interpretable signal, the method further comprising:
outputting, by the connection status indicator, a second user-interpretable signal when the physiological sensor is connected to the medical device, the second user-interpretable signal having a different modality, frequency, intensity, or pulse pattern than the first user-interpretable signal.

19. The method of claim 14, the data being first data, the method further comprising:
storing, in memory, second data indicating the physiological parameter when the physiological sensor is disconnected from the medical device.

20. The method of claim 19, further comprising:
outputting, by the physiological sensor to the medical device, the second data when the physiological sensor is communicatively connected to the medical device.
